(19) United States
(12) Patent Application Publication
(10) Pub. No.: US 2016/0171101 A1
(43) Pub. Date: Jun. 16, 2016

(54) HIGH LEVEL OF DETAIL NEWS MAPS AND IMAGE OVERLAYS

(71) Applicants: Rita Wouhaybi, Portland (CA); Steven Birkel, Portland, OR (US); Timothy Verrall, Pleasant Hills, CA (US); Mrigank Shekhar, Camas, WA (US); Lama Nachman, Santa Clara, CA (US)

(72) Inventors: Rita Wouhaybi, Portland (CA); Steven Birkel, Portland, OR (US); Timothy Verrall, Pleasant Hills, CA (US); Mrigank Shekhar, Camas, WA (US); Lama Nachman, Santa Clara, CA (US)

(21) Appl. No.: 14/369,228

(22) PCT Filed: Nov. 27, 2013
(86) PCT No.: PCT/US2013/072160

§ 371 Date: Jun. 27, 2014

(51) Int. Cl. G06F 17/30

(52) U.S. Cl. CPC G06F 17/30864

(57) ABSTRACT

Systems and methods may provide for extracting location data from a plurality of news items, wherein at least a portion of the location data has a first level of detail that is greater than or equal to a neighborhood, and using the location data to populate a news data store. Additionally, a response to a news query may be generated based on a requested location associated with the news query and the location data in the news data store, wherein the requested location has a second level of detail that is greater than or equal to the first level of detail and the response indicates one or more news items that correspond to the requested location. In one example, a graphical representation of the response is overlaid on one or more of a map corresponding to the requested location or an image of the requested location.

### TECHNICAL FIELD

Embodiments generally relate to news services. More particularly, embodiments relate to news services that enable high level of detail news maps and image overlays.

### BACKGROUND

Conventional online news services such as, for example, news.google.com may be configured to identify news stories at the global and national level, with little, if any, focus on local news stories. While local newspapers may also use web sites to deliver local news to end users, there remains considerable room for improvement. For example, online providers of local news may fail to adequately index news stories in a manner that enables users to identify and retrieve local news stories that are relevant to a specific location such as an address or intersection. Moreover, the news stories from conventional online providers may be limited in time (e.g., the past few hours, days, etc.).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a news service according to an embodiment;

FIG. 2 is an illustration of an example of various levels of level of detail according to an embodiment;

FIG. 3 is an illustration of an example of a news radius according to an embodiment;

FIGS. 4A and 4B are illustrations of examples of a news map and a news image, respectively, according to embodiments;

FIG. 5 is a block diagram of an example of a method of processing news queries according to an embodiment;

FIG. 6 is a block diagram of an example of a logic architecture according to an embodiment;

FIG. 7 is a block diagram of an example of a processor according to an embodiment; and

FIG. 8 is a block diagram of an example of a system according to an embodiment.

### DESCRIPTION OF EMBODIMENTS

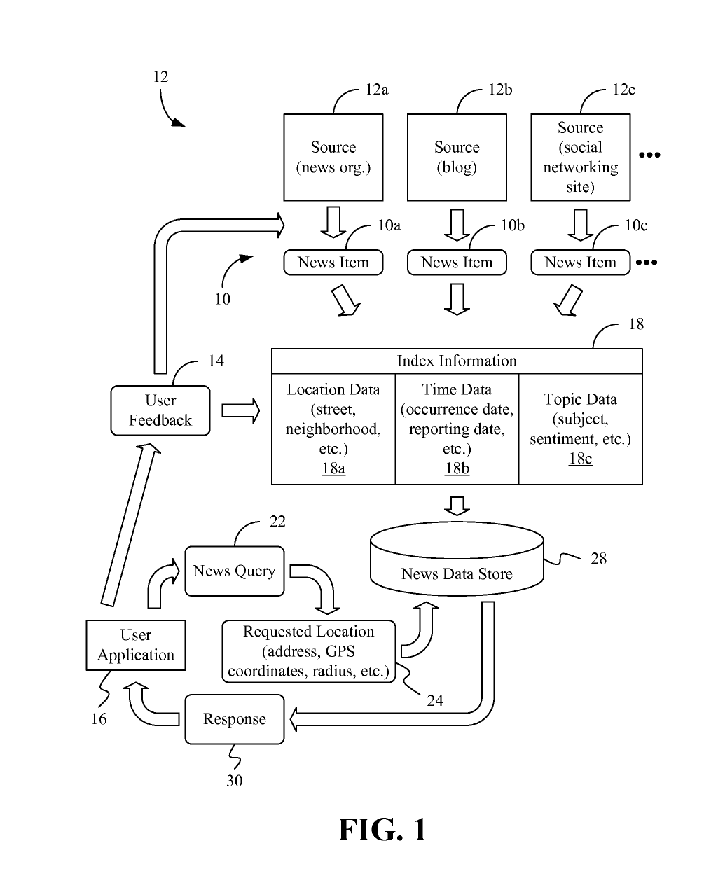

Turning now to FIG. 1, a news service that manages a plurality of news items 10 (10a-10c) is shown. In the illustrated example, the news items 10 are aggregated (e.g., pushed and/or pulled) from a plurality of different news sources 12 (12a-12c) such as news organizations (e.g., newspaper companies, Internet, television and/or radio broadcasters, cooperatives, etc.), blogs, social networking sites (e.g., TWITTER, FACEBOOK, LINKEDIN, INSTAGRAM, etc.), communities, government sources, and so forth. Thus, a first news item 10a might be a newspaper article written by a reporter affiliated with a first news source 12a (e.g., a particular news organization), a second news item 10b may be a blog posting from an individual affiliated with a second news source 12b (e.g., a particular blog), a third news item 10c might be a social networking posting from an individual via a third news source 12c (e.g., a particular social networking site), and so forth. The illustrated news items 10 therefore vary in the type of content as well as the point of origin.

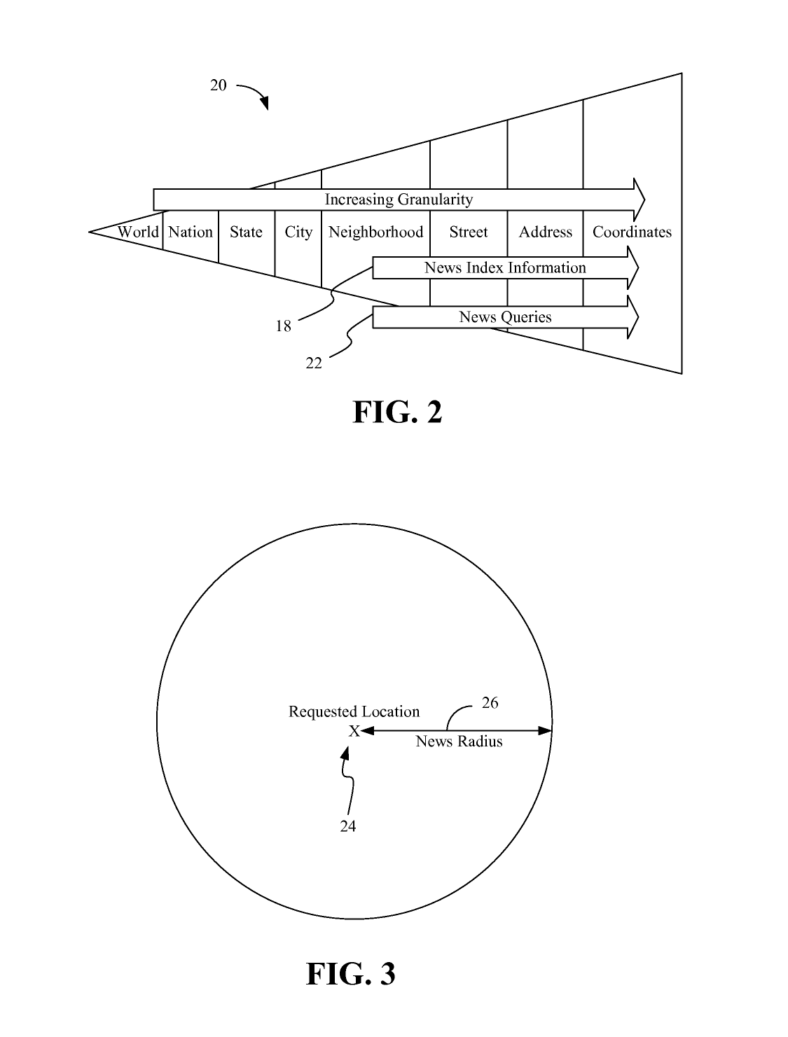

As will be discussed in greater detail, index information 18 (18a-18c) may be automatically extracted from the news items 10, wherein the index information 18 may include location data 18a (e.g., semantic number, business name, address, street, intersection, neighborhood), time data 18b (e.g., occurrence date, reporting date), topic data 18c (e.g., subject, sentiment, keywords), and so forth. The location data 18a may therefore have a relatively high level of detail (e.g., granularity, resolution) that enables enhanced servicing of news queries. In this regard, FIG. 2 shows a geographic pyramid 20 in which both the news index information 18 and one or more news queries 22 have a level of detail/granularity that is greater than or equal to a neighborhood (e.g., the neighborhood level of detail). Such an approach may therefore enable end users to obtain highly customized news results that are tailored to their specific location (e.g., address, Global Positioning System/GPS coordinates, etc.). Indeed, FIG. 3 demonstrates that a relatively tight news radius 26 (e.g., two blocks) may be established by the user around a requested location 24, wherein the requested location 24 may be very specific and the location data 18a (FIG. 1) may facilitate the identification of news items falling within the news radius 26. Users may also query using a semantic location such as city or neighborhood, where the boundary is not a circle.

With continued reference to FIG. 1, the location data 18a may also indicate a semantic location, cover a relatively wide area or be vague/broad, while still providing information that may be useful in the news indexing and retrieval processes. For example, one news item might state that “Northwest Cornelius Pass road was closed from U.S. Highway 30 to Northwest Skyline Boulevard after a log truck crash Monday morning, officials said”, whereas another news item may state that “[a]head of watching the St. Patrick's Day Parade at Mons Barracks in Aldershot, Hampshire, Kate suffered an embarrassing mishap when the heel of one of her shoes became stuck in a drain.” In the first instance, a particular section of road is identified and in the second instance, a semantic point of interest is identified. In either case, the identified location may be extracted and indexed as the location data 18a.

In addition, the location data 18a may be assigned a confidence score, which may be particularly useful for vague locations. In such a case, the center of a particular area may be designated as the location, but with a relatively low confidence score. The confidence score may be used to visualize the fact that the location of the event is not known completely, wherein the text used to determine the location may be provided to the user so that they may use their own lo judgment as to the reliability and/or accuracy of the location data 18a. Public databases may also be queried in order to increase the confidence or reliability of the location data 18a. Users may also send corrections or clarifications to certain geographical locations or time of incidents and the system will adjust its confidence based on the number of users reporting it and their reputation in the system.

The time data 18b may identify when a particular event occurred and/or when the occurrence and/or details of that event were reported. For example, multiple social networking postings (e.g., “tweets”) about a political pep rally taking place on a particular date (e.g., Oct. 11, 2013) may occur on that date and/or later in time (e.g., days, weeks, months and/or years later). In such a case, the time data 18b may indicate when the pep rally took place and optionally when each posting about the pep rally was made. Similarly, a local newspaper might report on a vandalism of a private residence a few days after the vandalism took place (e.g., Sep. 15, 2001), wherein only a single reporting of the incident may be made. Thus, the time data 18b may span a relatively wide period of time such as when an event is longer in nature (e.g., picketing). Additionally, the time data 18b may be assigned a confidence score based on the accuracy and/or reliability of the information used to extract the time data 18b.

Similarly, the age of the event and/or news item may be used to adjust the confidence in the associated location data 18a. For example, if the location data 18a reflects a semantic name such as the name of a hotel or landmark that might have changed identity, the confidence score in the location data 18a may be reduced. Also, public databases may be used to translate location names into GPS coordinates and vice versa, as needed.

The topic data 18c may identify the subject, category, sentiment, mood, keywords, etc., of the news items 10. For example, in the case of a social networking posting about a pep rally, the topic data 18c might indicate “politics” as a subject, keyword and/or category as well as indicate the overall mood (e.g., positive, negative) of the posting. In the case of the vandalism of a private residence, the topic data 18c may indicate “crime” as a subject, keyword and/or category. In yet another example, the topic data 18c may identify whether a news item is related to business (e.g., finance, industry specific) or personal (e.g., entertainment) issues.

Geographical databases and/or natural language processing (NLP) techniques/rules may be used to extract the location data 18a, the time data 18b and/or the topic data 18c and to generate the index information 18. NLP may involve drawing one or more semantic and/or fuzzy inferences from the content of the news items 10. Other types of information such as, for example, the source, tags, metadata, HTML (Hypertext Markup Language) code, author, title, and so forth, may also be indexed. The indexing process may also involve identifying a feature set to determine the probability of an item containing news rather than other types of topics (e.g., personal remarks).

The illustrated index information 18 is used to populate a news data store 28, which may be structured as a relational database, linked list, etc., or any combination thereof, and archived in an appropriate computer readable storage medium over long periods of time. Therefore, if a news query 22 is received from a user application 16 (e.g., mapping, navigation and/or imaging application running on a client device such as a desktop computer, notebook computer, tablet computer, convertible tablet, smart phone and/or mobile Internet device/MID), a requested location 24 may be identified in the news query 22 and matched against the contents of the news data store 28. For example, the user application 16 might be a web based mapping application that generates offline travel directions based on a starting and ending location. In such a case, the news query 22 may include the ending address and/or GPS coordinates of the trip, which may be used, along with a news radius such as the news radius 26 (FIG. 3), to search the news data store 28 and generate a response 30 to the news query 22. The response 30 may indicate one or more news items that correspond to the requested location.

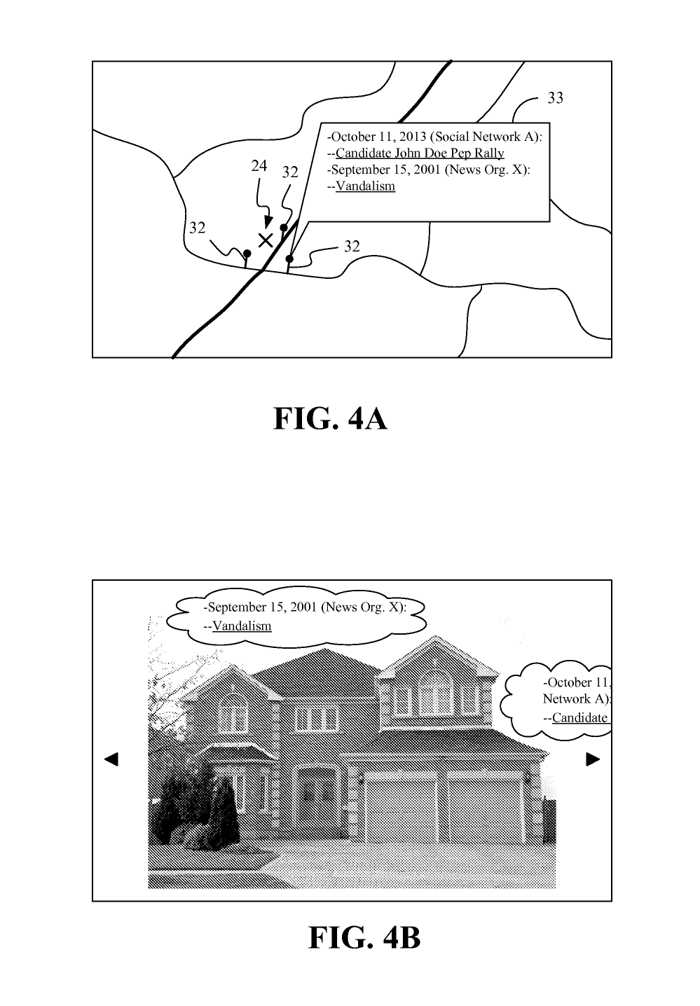

FIG. 4A demonstrates that a graphical representation 32 of the response 30 (FIG. 1) may be overlaid on a map corresponding to an ending location that represents the requested location 24. In the illustrated example, the graphical representation 32 is a pin that may be expanded to a larger box 33 for additional information by hovering a cursor over the pin 32, touching a screen location at the pin 32 (e.g., in touch screen devices), and so forth. Moreover, selecting (e.g., by clicking, touching, etc.) individual items in the box 33 may link the user to the full text of the news item in question. Other visual clues and/or graphical techniques such as shapes, colors, icons, etc., may also be used. Additionally, two or more news items may be clustered into the graphical representation 32 depending upon screen space and other considerations. In the illustrated example, a pep rally and vandalism occur close to one another geographically and are therefore clustered into the same graphical representation 32 of a pin. Clustering may also occur along other bases and/or vectors such as time, topic, etc.

Returning to FIG. 1, in another example, the user application 16 may be a navigation application that generates real-time travel directions, wherein the news query 22 may include present and/or future GPS coordinates that may be matched against the contents of the news data store 28. In such a case, a graphical representation of the response 30 may be overlaid on a live map corresponding to a current location that represents the requested location 24, wherein the user application 16 may obtain continual news updates as the user travels along the route in question.

The user application 16 may also be an imaging application that enables the user to capture images of his or her surroundings and use the captured images to obtain news items for the immediate vicinity. In such a case, the images may be embedded with coordinate information that is used to generate the news query 22 and identify the requested location 24. The position and orientation of the device capturing the image may also be used to generate the news query 22 and identify the requested location 24.

FIG. 4B demonstrates that a graphical representation 34 of the response 30 (FIG. 1) may be overlaid on an image of the requested location 24. The illustrated graphical representation 34 is a cloud that contains certain details of the relevant news items for the requested location 24, although other visualization techniques may be used. Additionally, the presence of news items for nearby locations (e.g., next door) may also be overlaid on the image. In the illustrated example, the user is prompted to aim the image capture device to the home to the right in order to view information regarding the house next door.

Returning again to FIG. 1, the aggregation of the news items 10 may also take into consideration a crowd source (not shown), a source index (not shown) and/or user feedback 14 obtained from the user application 16. In this regard, the user may explicitly select one or more of the sources 12 via the feedback 14, an appropriate user interface (UI) and/or one or more user preferences. Additionally, the user feedback 14 may include authentication information that may be used to verify authorization to access subscription-based news stores from particular sources. The authentication information may also be provided via the news query 22. The user may also be prompted for the user feedback 14 by one or more recommendation systems that take into consideration user behavior, demographics and interests from previous interactions. The user feedback 14 may also enable users to correct information that was pulled from the databases. In this manner, the system may involve crowd-sourcing in order improve the accuracy of NLP techniques.

Moreover, if one or more of the sources 12 are automatically selected, the source index may be used to rate them for accuracy and relevance of their content. For example, a particular newspaper (e.g., NY TIMES, OREGONIAN) may be assigned a relatively high relevance, whereas the blog of a person or a community that reports on local events but also includes personal remarks, advertisements, etc., may be assigned a relatively low relevance. The user feedback 14 may also be used to influence the rating of one or more of the news sources 12. In addition, the response 30 may be shared with individuals other than the user originating the news query 22. The rating could also be user specific or even a group of users, e.g. a group with a particular political affiliation might value a certain source or a subset of sources more than others while their opposition will rate the same sources poorly. Techniques, such as collaborative filtering, could be used to identify users preferences and bin them into groups that match their affiliations, beliefs, values, and interests.

Thus, a user driving home from work and seeing the remnants of an accident may use a navigation application to issue the news query 22 in order to immediately obtain an indication of news items discussing and/or detailing the accident (e.g., people involved, injuries, detours), wherein the index information associated with those news items may be overlaid on the navigation screen of the vehicle being operated by the user. In another example, a user conducting a house search in a particular neighborhood may use a handheld device to issue the news query 22 in order to obtain an indication of news items discussing and/or detailing events that have occurred in that neighborhood over the past two years, and other content that is related such as police reports. In this regard, the user is not limited to crime reports and may retrieve both positive and negative news stories. In yet another example, a couple staying at a bed and breakfast (B&B) in a particular town may use a desktop computer to issue the news query 22 in order to determine who else has stayed and/or celebrated at that particular B&B over the past century.

Additionally, an individual may use a handheld device to issue the news query 22 in order to determine all “negative” events taking place in the last twelve hours within a radius of fifty feet and receive highly accurate results. In yet another example, a user may generate the news query 22 to see all news items within a one mile radius over the last twenty years, or impose other restrictions on the query.

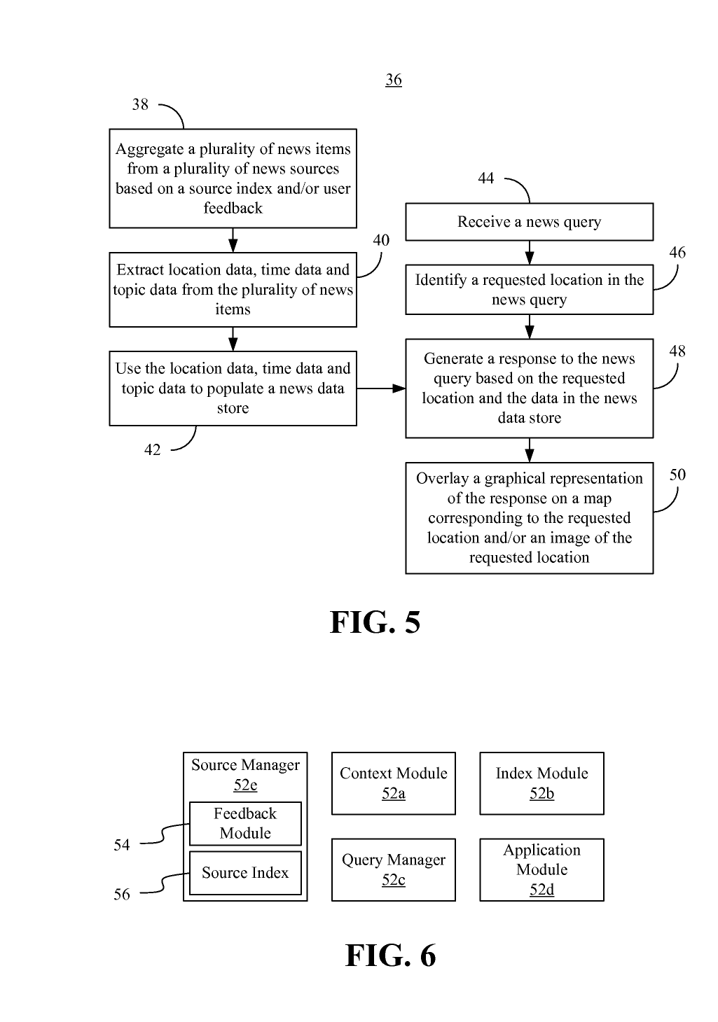

Turning now to FIG. 5, a method 36 of processing news queries is shown. The method 36 may be implemented as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 36 may be written in any combination of one or more programming languages, including an object oriented programming language such as Java, Smalltalk, C++ or the like and conventional procedural programming languages, such as the “C” programming language or similar programming languages.

Illustrated processing block 38 provides for aggregating a plurality of news items from a plurality of news sources based on one or more of a crowd source, user feedback or a source index. As already noted, the news sources may include, for example, news organizations, blogs, social networking sites, and so forth. Location data, time data and topic data may be extracted from the plurality of news items at block 40, wherein extracting the location, time and/or topic data may involve applying one or more natural language processing rules and geographical databases to the plurality of news items. In one example, at least a portion of the location data has a level of detail (e.g., a first level of detail) that is greater than or equal to the neighborhood level (e.g., neighborhood, street, address and/or coordinate level of level of detail). Illustrated block 42 uses the location data, the time data and the topic data to populate a news data store. Blocks 38, 40 and 42 may therefore be repeated as needed (e.g., periodically, on demand) to maintain and/or update the news data store.

A news query may be received at block 44, wherein a requested location may be identified in the news query at block 46. As already noted, the news query may be associated with a mapping application, a navigation application, an imaging application, etc., wherein the requested location may have a level of detail (e.g., a second level of detail) that is greater than or equal to the level of detail of at least a portion of the location data extracted at block 40. For example, the requested location might be a GPS coordinate and the location data extracted from one or more news items may be a GPS coordinate, address, intersection, street, and/or neighborhood within a specified distance (e.g., news radius) of the requested GPS coordinate. Illustrated block 48 generates a response to the news query based on the requested location and the data in the news data store. The response may indicate one or more news items that correspond to the requested location. A graphical representation of the response may be overlaid at block 50 on a map corresponding to the requested location and/or an image of the requested location. In one example, data associated with two or more news items may be clustered into the graphical representation.

FIG. 6 shows a logic architecture 52 (52a-52e) to process news queries. The logic architecture 52 may generally implement one or more aspects of the method 36 (FIG. 5), already discussed. In the illustrated example, a context module 52a extracts location data from a plurality of news items, wherein at least a portion of the location data has a first level of detail that is greater than or equal to a neighborhood. The context module 52a may also extract time data and topic data from the plurality of news items. In one example, extracting the data involves applying one or more NLP rules and geographical databases to the plurality of news items. Additionally, an index module 52b may use the location data, time data and/or topic data to populate a news data store. The illustrated architecture 52 also includes a query manager 52c that generates responses to news queries based on requested locations associated with the news queries and the location data, the time data and/or the topic data in the news data store. The requested locations may have a second level of detail that is greater than or equal to the first level of detail of at least a portion of the location data, and the responses may indicate one or more news items that correspond to the requested locations.

In one example, an application module 52d overlays graphical representations of the responses on maps corresponding to the requested locations and/or images of the requested locations. The application module 52d may also cluster data associated with two or more news items into the graphical representations. Moreover, the illustrated architecture 52 also includes a source manager 52e to aggregate the plurality of news items from a plurality of news sources, wherein the plurality of news sources may include news organizations, blogs, social networking sites, and so forth. The source manager 52e may use a feedback module 54 and/or a source index 56 to aggregate the plurality of news items.

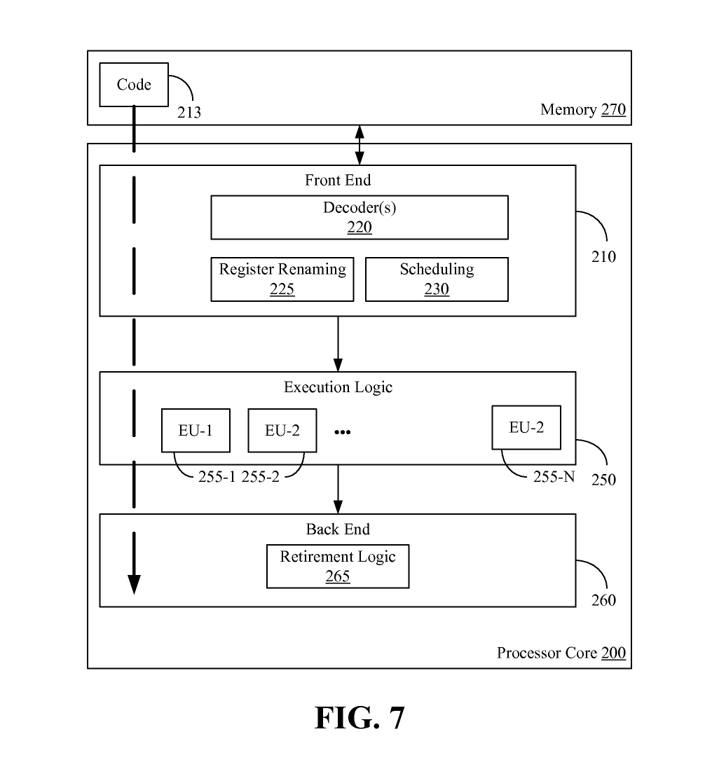

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the method 36 (FIG. 5), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

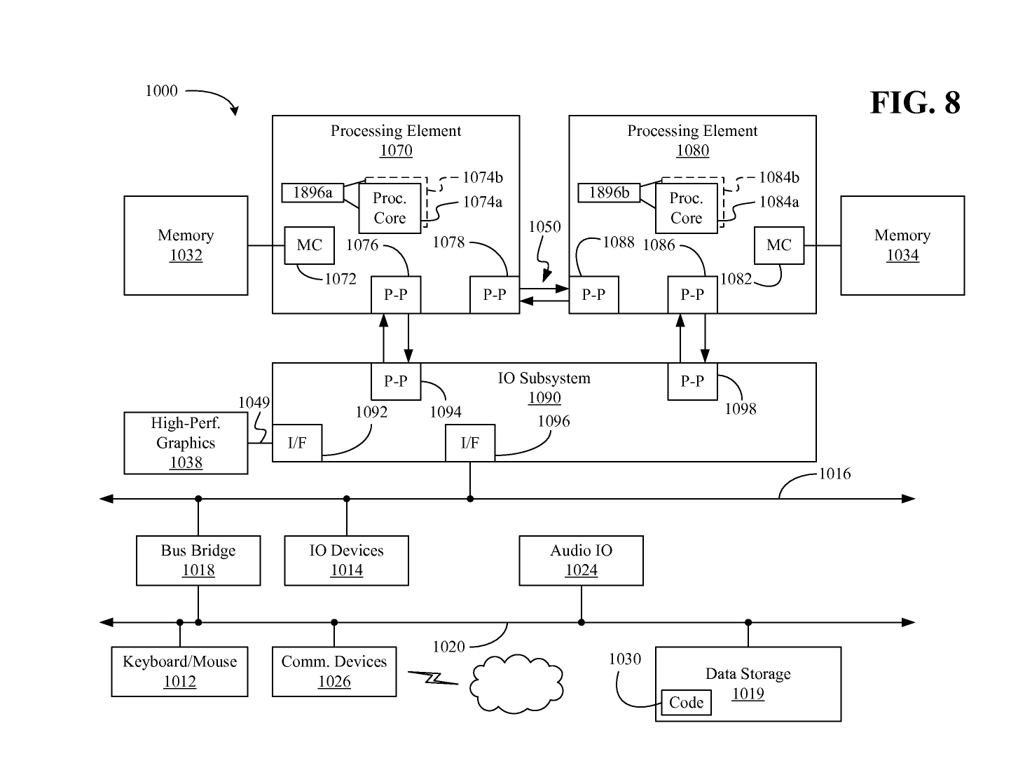

Referring now to FIG. 8, shown is a block diagram of a system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., cameras) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 36 (FIG. 5), already discussed, and may be similar to the code 213 (FIG. 7), already discussed. Further, an audio I/O 1024 may be coupled to second bus 1020.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### ADDITIONAL NOTES AND EXAMPLES

Example 1 may include an apparatus to process news queries, comprising a source manager to aggregate a plurality of news items from a plurality of news sources based on one or more of a crowd source, user feedback or a source index, the plurality of news sources including one or more of a news organization, a blog, a community, a government source or a social networking site. The apparatus may also include a context module to extract location data, time data and topic data from the plurality of news items, wherein at least a portion of the location data has a first level of detail that is greater than or equal to a neighborhood and the topic data includes one or more of a subject, a sentiment or a keyword, an index module to use the location data, the time data the topic data, and sentiment data to populate a news data store, and a query manager to generate a response to a news query based on a requested location associated with the news query and based on the location data, the time data and the topic data in the news store, wherein the requested location is to have a second level of detail that is greater than or equal to the first level of detail and the response is to indicate one or more news items that correspond to the requested location.

Example 2 may include the apparatus of Example 1, further including an application module to overlay a graphical representation of the response on one or more of a map corresponding to the requested location or an image of the requested location.

Example 3 may include the apparatus of Example 2, wherein the application module is to cluster data associated with two or more news items into the graphical representation.

Example 4 may include the apparatus of any one of Examples 1 to 3, wherein the context module is to apply one or more natural language processing rules and geographical databases to the plurality of news items to extract the location data.

Example 5 may include a method of processing news queries, comprising extracting location data from a plurality of news items, wherein at least a portion of the location data has a first level of detail that is greater than or equal to a neighborhood, using the location data to populate a news data store and generating a response to a news query based on a requested location associated with the news query and the location data in the news store, wherein the requested location has a second level of detail that is greater than or equal to the first level of detail and the response indicates one or more news items that correspond to the requested location.

Example 6 may include the method of Example 5, further including overlaying a graphical representation of the response on one or more of a map corresponding to the requested location or an image of the requested location.

Example 7 may include the method of Example 6, further including clustering data associated with two or more news items into the graphical representation.

Example 8 may include the method of Example 5, further including extracting time data from the plurality of news items, and using the time data to populate the news data store, wherein the time data is used to generate the response to the news query.

Example 9 may include the method of Example 5, further including extracting topic data from the plurality of news items, wherein the topic data includes one or more of a subject, a sentiment or a keyword, and using the topic data to populate the news data store, wherein the topic data is used to generate the response to the news query.

Example 10 may include the method of any one of Examples 5 to 9, wherein extracting the location data includes applying one or more natural language processing rules and geographical databases to the plurality of news items.

Example 11 may include the method of any one of Examples 5 to 9, further including aggregating the plurality of news items from a plurality of news sources based on one or more of a crowd source, user feedback or a source index, the plurality of news sources including one or more of a news organization, a blog, a blog, a community, a government source or a social networking site.

Example 12 may include at least one computer readable storage medium comprising a set of instructions, which, if executed by a computing device, cause the computing device to extract location data from a plurality of news items, wherein at least a portion of the location data has a first level of detail that is greater than or equal to a neighborhood, use the location data to populate a news data store, and generate a response to a news query based on a requested location associated with the news query and the location data in the news data store, wherein the requested location is to have a second level of detail that is greater than or equal to the first level of detail and the response is to indicate one or more news items that correspond to the requested location.

Example 13 may include the at least one computer readable storage medium of claim 12, wherein the instructions, if executed, cause a computing device to overlay a graphical representation of the response on one or more of a map corresponding to the requested location or an image of the requested location.

Example 14 may include the at least one computer readable storage medium of claim 13, wherein the instructions, if executed, cause a computing device to cluster data associated with two or more news items into the graphical representation.

Example 15 may include the at least one computer readable storage medium of claim 12, wherein the instructions, if executed, cause a computing device to extract time data from the plurality of news items and use the time data to populate the news data store, wherein the time data is to be used to generate the response to the news query.

Example 16 may include the at least one computer readable storage medium of claim 12, wherein the instructions, if executed, cause a computing device to extract topic data from the plurality of news items, wherein the topic data includes one or more of a subject, a sentiment or a keyword and use the topic data to populate the news data store, wherein the topic data is to be used to generate the response to the news query.

Example 17 may include the at least one computer readable storage medium of any one of claims 12 to 16, wherein the instructions, if executed, cause a computing device to apply one or more natural language processing rules and geographical databases to the plurality of news items to extract the location data.

Example 18 may include the at least one computer readable storage medium of any one of claims 12 to 16, wherein the instructions, if executed, cause a computing device to aggregate the plurality of news items from a plurality of news sources based on one or more of a crowd source, user feedback or a source index, the plurality of news sources including one or more of a news organization, a blog, a blog, a community, a government source or a social networking site.

Example 19 may include an apparatus to process news queries, comprising a context module to extract location data from a plurality of news items, wherein at least a portion of the location data has a first level of detail that is greater than or equal to a neighborhood, an index module to use the location data to populate a news data store, and a query manager to generate a response to a news query based on a requested location associated with the news query and the location data in the news data store, wherein the requested location is to have a second level of detail that is greater than or equal to the first level of detail and the response is to indicate one or more news items that correspond to the requested location.

Example 20 may include the apparatus of Example 19, further including an application module to overlay a graphical representation of the response on one or more of a map corresponding to the requested location or an image of the requested location.

Example 21 may include the apparatus of Example 20, wherein the application module is to cluster data associated with two or more news items into the graphical representation.

Example 22 may include the apparatus of Example 19, wherein the context module is to extract time data from the plurality of news items and the index module is to use the time data to populate the news data store, wherein the topic data includes one or more of a subject, a sentiment or a keyword, and wherein the time data is to be used to generate the response to the news query.

Example 23 may include the apparatus of Example 19, wherein the context module is to extract topic data from the plurality of news items and the index module is to use the topic data to populate the news data store, wherein the topic data is to be used to generate the response to the news query.

Example 24 may include the apparatus of any one of Examples 19 to 23, wherein the context module is to apply one or more natural language processing rules and geographical databases to the plurality of news items to extract the location data.

Example 25 may include the apparatus of any one of Examples 19 to 23, further including a source manager to aggregate the plurality of news items from a plurality of news sources based on one or more of a crowd source, user feedback or a source index, the plurality of news sources including one or more of a news organization, a blog or a social networking site.

Example 26 may include an apparatus to process news queries, comprising means for performing the method of any one of Examples 5 to 11.

Thus, techniques described herein may therefore extract contextual data such as, for example, location (e.g., semantic or specific), time, topic, etc., from news items and present the extracted data to users in the form of graphical overlays, pins or other visual clues on maps and/or images. Moreover, a relatively small news radius may be used to retrieve news items that are highly targeted to the user's location and/or other interests.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. An apparatus to process news queries, comprising:
a source manager to aggregate a plurality of news items from a plurality of news sources based on one or more of a crowd source, user feedback or a source index, the plurality of news sources including one or more of a news organization, a blog, a community, a government source or a social networking site;
a context module to extract location data, time data and topic data from the plurality of news items, wherein at least a portion of the location data has a first level of detail that is greater than or equal to a neighborhood and the topic data includes one or more of a subject, a sentiment or a keyword;
an index module to use the location data, the time data and the topic data to populate a news data store; and
a query manager to generate a response to a news query based on a requested location associated with the news query and based on the location data, the time data and the topic data in the news data store, wherein the requested location is to have a second level of detail that is greater than or equal to the first level of detail and the response is to indicate one or more news items that correspond to the requested location.

27. The apparatus of claim 26, further including an application module to overlay a graphical representation of the response on one or more of a map corresponding to the requested location or an image of the requested location.

28. The apparatus of claim 27, wherein the application module is to cluster data associated with two or more news items into the graphical representation.

29. The apparatus of claim 26, wherein the context module is to apply one or more natural language processing rules and geographical databases to the plurality of news items to extract the location data.

30. A method of processing news queries, comprising:
extracting location data from a plurality of news items, wherein at least a portion of the location data has a first level of detail that is greater than or equal to a neighborhood;
using the location data to populate a news data store; and
generating a response to a news query based on a requested location associated with the news query and the location data in the news data store, wherein the requested location has a second level of detail that is greater than or equal to the first level of detail and the response indicates one or more news items that correspond to the requested location.

31. The method of claim 30, further including overlaying a graphical representation of the response on one or more of a map corresponding to the requested location or an image of the requested location.

32. The method of claim 31, further including clustering data associated with two or more news items into the graphical representation.

33. The method of claim 30, further including:
extracting time data from the plurality of news items; and
using the time data to populate the news data store, wherein the time data is used to generate the response to the news query.

34. The method of claim 30, further including:
extracting topic data from the plurality of news items, wherein the topic data includes one or more of a subject, a sentiment or a keyword; and
using the topic data to populate the news data store, wherein the topic data is used to generate the response to the news query.

35. The method of claim 30, wherein extracting the location data includes applying one or more natural language processing rules and geographical databases to the plurality of news items.

36. The method of claim 30, further including aggregating the plurality of news items from a plurality of news sources based on one or more of a crowd source, user feedback or a source index, the plurality of news sources including one or more of a news organization, a blog, a blog, a community, a government source or a social networking site.

37. At least one computer readable storage medium comprising a set of instructions which, if executed by a computing device, cause the computing device to:
extract location data from a plurality of news items, wherein at least a portion of the location data has a first level of detail that is greater than or equal to a neighborhood;
use the location data to populate a news data store; and
generate a response to a news query based on a requested location associated with the news query and the location data in the news data store, wherein the requested location is to have a second level of detail that is greater than or equal to the first level of detail and the response is to indicate one or more news items that correspond to the requested location.

38. The at least one computer readable storage medium of claim 37, wherein the instructions, if executed, cause a computing device to overlay a graphical representation of the response on one or more of a map corresponding to the requested location or an image of the requested location.

39. The at least one computer readable storage medium of claim 38, wherein the instructions, if executed, cause a computing device to cluster data associated with two or more news items into the graphical representation.

40. The at least one computer readable storage medium of claim 37, wherein the instructions, if executed, cause a computing device to:
extract time data from the plurality of news items; and
use the time data to populate the news data store, wherein the time data is to be used to generate the response to the news query.

41. The at least one computer readable storage medium of claim 37, wherein the instructions, if executed, cause a computing device to:
extract topic data from the plurality of news items, wherein the topic data includes one or more of a subject, a sentiment or a keyword; and
use the topic data to populate the news data store, wherein the topic data is to be used to generate the response to the news query.

42. The at least one computer readable storage medium of claim 37, wherein the instructions, if executed, cause a computing device to apply one or more natural language processing rules and geographical databases to the plurality of news items to extract the location data.

43. The at least one computer readable storage medium of claim 37, wherein the instructions, if executed, cause a computing device to aggregate the plurality of news items from a plurality of news sources based on one or more of a crowd source, user feedback or a source index, the plurality of news sources including one or more of a news organization, a blog, a blog, a community, a government source or a social networking site.

44. An apparatus to process news queries, comprising:
a context module to extract location data from a plurality of news items, wherein at least a portion of the location data has a first level of detail that is greater than or equal to a neighborhood;
an index module to use the location data to populate a news data store; and
a query manager to generate a response to a news query based on a requested location associated with the news query and the location data in the news data store, wherein the requested location is to have a second level of detail that is greater than or equal to the first level of detail and the response is to indicate one or more news items that correspond to the requested location.

45. The apparatus of claim 44, further including an application module to overlay a graphical representation of the response on one or more of a map corresponding to the requested location or an image of the requested location.

46. The apparatus of claim 45, wherein the application module is to cluster data associated with two or more news items into the graphical representation.

47. The apparatus of claim 44, wherein the context module is to extract time data from the plurality of news items and the index module is to use the time data to populate the news data store, wherein the time data is to be used to generate the response to the news query.

48. The apparatus of claim 44, wherein the context module is to extract topic data from the plurality of news items and the index module is to use the topic data to populate the news data store, wherein the topic data includes one or more of a subject, a sentiment or a keyword, and wherein the topic data is to be used to generate the response to the news query.

49. The apparatus of claim 44, wherein the context module is to apply one or more natural language processing rules and geographical databases to the plurality of news items to extract the location data.

50. The apparatus of claim 44, further including a source manager to aggregate the plurality of news items from a plurality of news sources based on one or more of a crowd source, user feedback or a source index, the plurality of news sources including one or more of a news organization, a blog, a blog, a community, a government source or a social networking site.
